(19) United States
(12) Patent Application Publication
(10) Pub. No.: US 2009/0002989 A1
(43) Pub. Date: Jan. 1, 2009

(54) INTEGRALLY FORMED REFLECTOR STRUCTURE, BACKLIGHT MODULE USING THE SAME REFLECTOR STRUCTURE AND METHOD FOR ASSEMBLING THE SAME BACKLIGHT MODULE

(76) Inventors: I-Peng HUNG, Hsinchu (TW); Ping-Feng Hwang, Hsinchu (TW); Lin-Chu Weng, Hsinchu (TW)

Correspondence Address: SINORICA, LLC, 528 FALLSGROVE DRIVE, ROCKVILLE, MD, 20850, US

(21) Appl. No.: 11/966,161

(22) Filed: Dec. 28, 2007

(30) Foreign Application Priority Data
Jun. 26, 2007 (TW) 96123024

(51) Int. Cl. F21V 7/00; F21V 21/00

(52) U.S. Cl. 362/249; 362/341

(57) ABSTRACT

The present invention discloses an integrally formed reflector structure, a backlight module using the same reflector structure and a method for assembling the same module. An accommodation spacer and a plurality of lamp-support members are formed on a reflector baseplate with a vacuum-forming method, and a plurality of extension portions extend from the edges of the accommodation space. Further, pluralities of support pins, reflecting members, lamp-fixing members, positioning members, bent portions, etc. are formed in the appropriate positions of the reflector baseplate or the extension portions with a vacuum-forming method. Besides, the extension portions are bent from the bent portions to form a plurality of grooves, which are used to secure optical films in cooperation with the positioning members.

### BACKGROUND OF THE INVENTION

1. Field of the Invention

The present invention relates to a reflector structure, particularly to an integrally formed reflector structure, a backlight module using the same reflector structure and a method for assembling the same backlight module.

2. Description of the Related Art

Refer to FIG. 1(A) and FIG. 1(B) which are respectively a diagram schematically showing a conventional backlight module 1 and an exploded view of the conventional backlight module 1. In the conventional backlight module 1, a plurality of support surfaces (not shown) extend from a metal baseplate 35. A reflector plate 10 is placed on the support surfaces. The reflector plate 10 has a recessed surface 11. The recessed surface 11 is aligned to the metal baseplate 35 via a plurality of surfaces extending from the recessed surface 11. A plurality of lamps 50 are arranged on the recessed surface 11 of the reflector plate 10. A plurality of lamp-support seats 12 for securing the lamps 50 at specified positions are arranged on the recessed surface 11 of the reflector plate 10 and corresponding to the lamps 50. A plurality of lamp-fixing seats 16 is arranged corresponding to the lamps 50 and used to position the lamps 50 from two ends thereof. Optical films 40, such as a diffuser and a polarizer, are sequentially arranged above the reflector plate 10. A plurality of support pins 14 is also arranged on the recessed surface 11 of the reflector plate 10 to support the optical films 40 and prevent the optical films 40 from depression. A plastic frame 15 is used to encase the metal baseplate 35, reflector plate 10, optical films 40 and lamp-fixing seats 16 from the upside and then secure them. Thereby, a backlight module is completed.

Refer to FIG. 1(C) which is a flowchart of a method for assembling the conventional backlight module 1. In Step S01, different molds are used to fabricate pluralities of lamp-support seats 12 and support pins 14, and the lamp-support seats 12 and the support pins 14 are arranged on the recessed surface 11 of the reflector plate 10. In Step S02, the metal baseplate 35 is provided. In Step S03, the reflector plate 10 is installed on the metal baseplate 35 securely. In Step S04, lamps 50 are arranged on the reflector plate 10 and secured with lamp-fixing seats 16. In Step S05, optical films 40, such as a diffuser, a polarizer, etc., are arranged above the reflector plate 10. In Step S06, the plastic frame 15 is used to encase the metal baseplate 35, reflector plate 10, optical films 40 and lamp-fixing seats 16 from the upside and then secure them to complete a backlight module.

From the above description, it is known that a conventional backlight module needs a lot of components including: lamp-support seats, support pins, lamp-fixing seats, and a plastic frame. The multitude of components not only needs more molds but also requires higher mold precision. Further, the complicated assembly process needs longer fabrication time and more manpower.

### SUMMARY OF THE INVENTION

One objective of the present invention is to provide an integrally formed reflector structure used in a backlight module, and a method for assembling the backlight module using the integrally formed reflector structure.

The embodiment of the present invention has at least one of or some of or all the following advantages:
1. Lamp-support members, support pins, lamp-fixing members, etc. are all directly formed on a reflector baseplate with a vacuum-forming method, which decreases the manpower of mold fabrication, reduces the cost of molds and components, and simplifies the assembly process;
2. The extension portions of the vacuum-formed integrally formed reflector structure are bent from the bent portions to form grooves, which replaces the conventional plastic frame to accommodate optical films; and
3. The vacuum-formed reflector structure is an integrally formed component, which reduces the costs of design, fabrication and maintenance of molds and simplifies the assembly process of a backlight module without sacrificing the reliability and light-emitting capability of the backlight module.

The other objectives and advantages of the present invention will be revealed in the following description of the present invention.

To achieve at least one of or some of or all the above-mentioned objectives, one embodiment of the present invention proposes an integrally formed reflector structure, which is to be used in a backlight module and accommodates a plurality of optical films. The integrally formed reflector structure comprises a reflector baseplate and a plurality of lamp-support members. The reflector baseplate has an accommodation space. The lamp-support members are formed inside the accommodation space and used to support a plurality of lamps. A plurality of support pins is also formed inside the accommodation space and used to support optical films. The accommodation space, the plurality of lamp-support members and the plurality of support pins are all formed on the reflector baseplate with a vacuum-forming method. The reflector baseplate also has a plurality of reflecting members used to reflect the light emitted by lamps and enhance the brightness of the backlight module. A plurality of lamp-fixing members is also formed on the appropriate positions of the reflector baseplate with a vacuum-forming method and used to secure the lamps. The edges of the accommodation space have a plurality of extension portions. Pluralities of bent portions and positioning members are formed on the extension portions with a vacuum-forming method. The bent portions are pre-formed to reduce the probability of fracture occurring in bending the extension portions. The extension portions are bent from the bent portions to form a plurality of grooves to accommodate optical films. The positioning members are used to position the optical films. A plurality of holes may also be formed on the appropriate positions of the vacuum-form reflector baseplate and used to fix the reflector baseplate and the optical films.

Another embodiment of the present invention also proposes a method for assembling a backlight module using the integrally formed reflector structure, which comprises the following steps: (A) providing a reflector baseplate; (B) forming an accommodation space and a plurality of lamp-support members on the reflector baseplate; and (C) assembling a plurality of optical films, the reflector baseplate and a support frame sequentially with a top down manner, and securing them together. In Step (B), a plurality of support pins, a plurality of reflecting members and a plurality of lamp-fixing members are formed in the accommodation space of the reflector structure with a vacuum-forming method. Further, in Step (B), a plurality of bent portions and a plurality of positioning members are formed on the extension portions extending the edged of the accommodation space with a vacuum-forming method. Before Step (C), the extension portions extending from the edges of the accommodation space are bent to accommodate the optical films. Further, before Step (C), a plurality of lamps is installed inside the accommodation space. In Step (C), a plurality of holes is formed on the reflector baseplate. In Step (C), a screwing method, adhesion method or press-fit method is used to secure the optical films, the reflector baseplate and the support frame.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1(A) is a diagram schematically showing a conventional backlight module;

FIG. 1(B) is an exploded view of the backlight module shown in FIG. 1(A);

FIG. 1(C) is a flowchart of a method for assembling the backlight module shown in FIG. 1(A);

FIG. 2(A) is a perspective view schematically showing an integrally formed reflector structure according to one embodiment of the present invention;

FIG. 2(B) is a sectional view schematically showing a lamp-support member of the reflector structure shown in FIG. 2(A);

FIG. 2(C) is a sectional view schematically showing a support pin of the reflector structure shown in FIG. 2(A);

FIG. 2(D) is a sectional view schematically showing reflecting members of the reflector structure shown in FIG. 2(A);

FIG. 2(E) is a sectional view schematically showing a lamp-fixing member of the reflector structure shown in FIG. 2(A);

FIG. 3(A) is a perspective view schematically showing an integrally formed reflector structure according to another embodiment of the present invention;

FIG. 3(B) is a top view of the integrally formed reflector structure shown in FIG. 3(A);

FIG. 3(C) is a sectional view of the integrally formed reflector structure shown in FIG. 3(A);

FIG. 3(D) is a sectional view schematically showing a positioning member of the reflector structure shown in FIG. 3(A);

FIG. 3(E) and FIG. 3(F) are diagrams schematically showing the process of forming grooves of the reflector structure shown in FIG. 3(A);

FIG. 3(G) is a sectional view schematically showing that a plurality of optical structures is accommodated in the grooves of the reflector structure shown in FIG. 3(A);

FIG. 4(A) is an exploded view schematically showing a backlight module using an integrally formed reflector structure according to one embodiment of the present invention.

FIG. 4(B) is a partially enlarged section view of the assembly of the integrally formed reflector structure and one support frame of the backlight module shown in FIG. 4(A);

FIG. 4(C) is a partially enlarged section view of the assembly the integrally formed reflector structure and another support frame of the backlight module shown in FIG. 4(A); and

FIG. 5 is a flowchart of a method for assembling a backlight module using an integrally formed reflector structure according to one embodiment of the present invention.

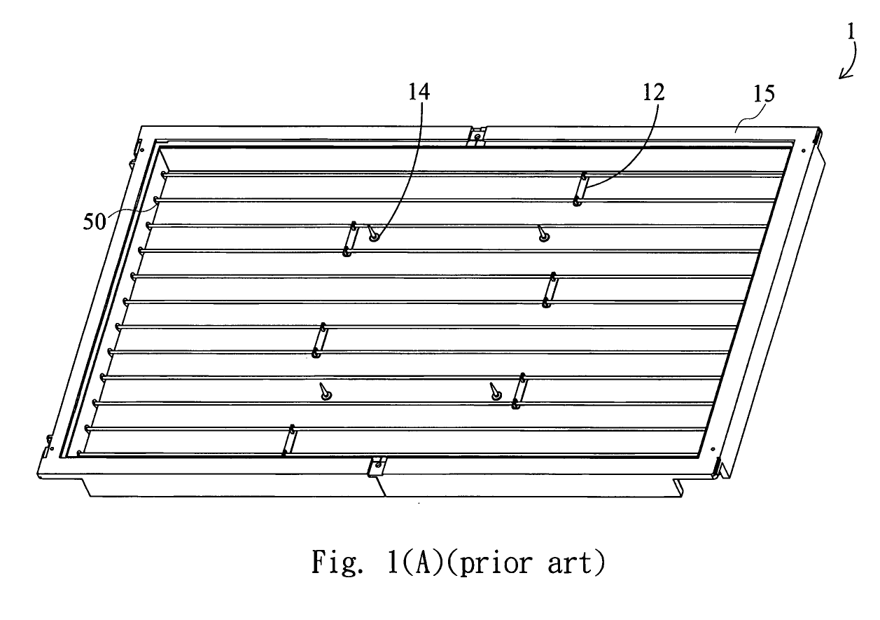

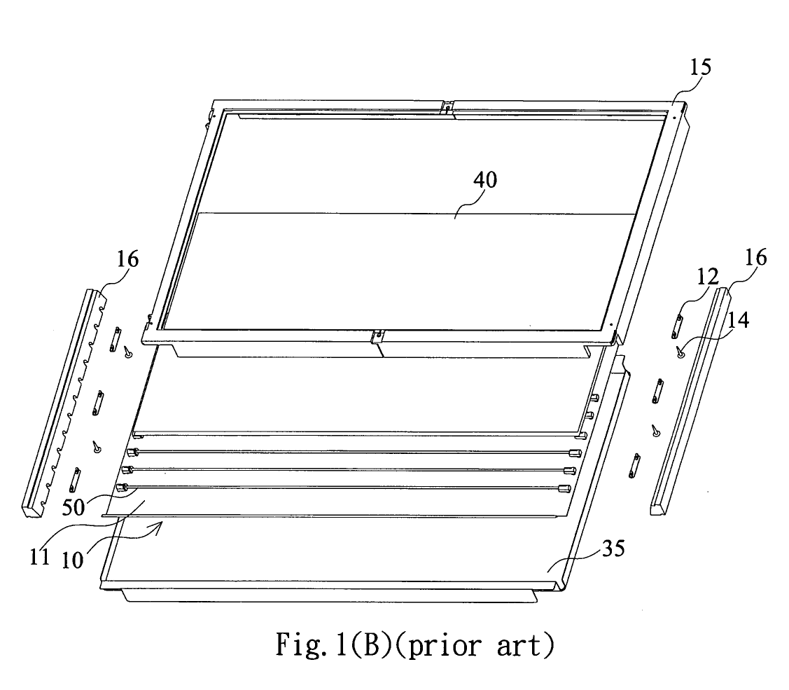

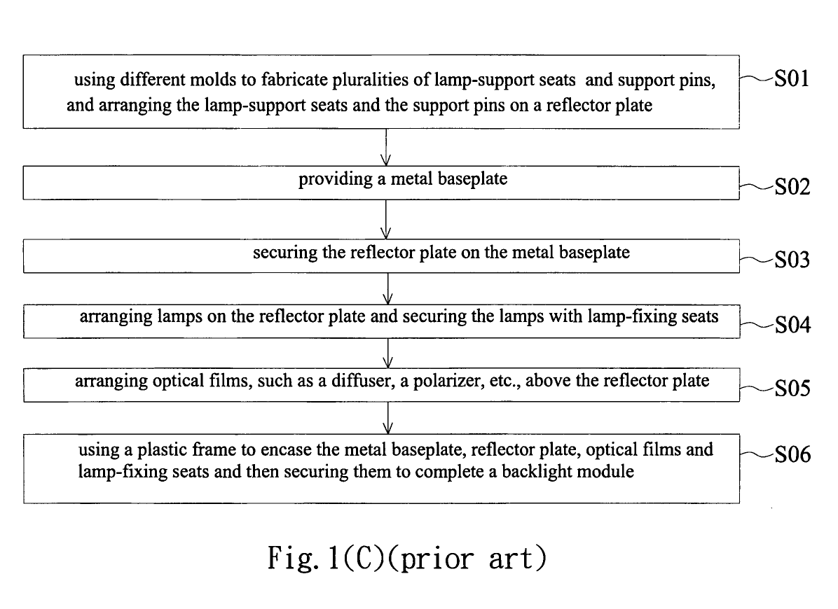

### DETAILED DESCRIPTION OF THE INVENTION

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

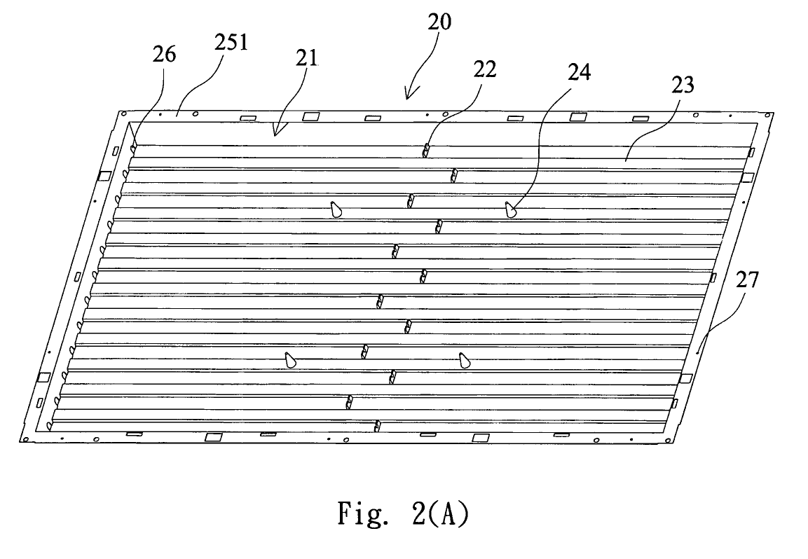

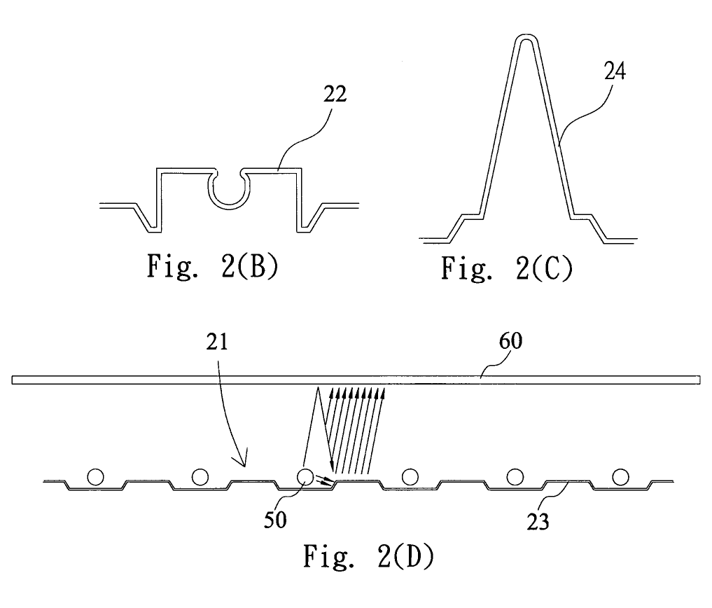

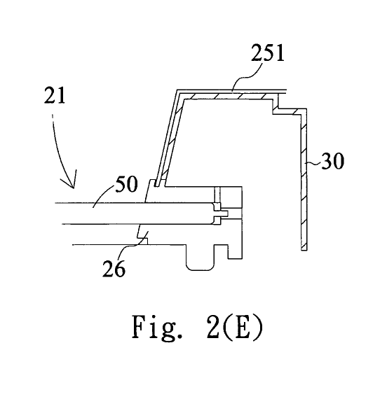

Refer to from FIG. 2(A) to FIG. 2(E). FIG. 2(A) is a perspective view schematically showing a integrally formed reflector structure according to an embodiment of the present invention. The integrally formed reflector structure of the present embodiment comprises a reflector baseplate 20 which is vacuum-formed to have an accommodation space 21, a plurality of lamp-support members 22, a plurality of support pins 24, a plurality of reflecting members 23, a plurality of lamp-fixing members 26, and the pluralities of lamp-support members 22, support pins 24, reflecting members 23 and lamp-fixing members 26 are all disposed inside the accommodation space 21. Besides, a plurality of lamps 50 are installed inside the accommodation space 21.

FIG. 2(B) is a sectional view schematically showing one lamp-support member 22 inside the accommodation space 21. The lamp-support members 22 are used to support the lamps 50. The number and positions of the lamp-support members 22 are dependent on the dimensions of the backlight module.

FIG. 2(C) is a sectional view schematically showing one support pin 24. The support pins 24 are used to support optical films (not shown in the drawing). The number and positions of the support pins 24 are also dependent on the dimensions of the backlight module.

The reflecting members 23 are used to reflect the light emitted by the lamps 50 and enhance the brightness of the backlight module, as show in FIG. 2(D), where the arrows indicate the direction of light propagation. The light reaching a display panel 60 includes the light emitted by the lamps 50 and the light reflected by the reflecting members 23. The reflecting member 23 shown in FIG. 2(D) has a section of a wide trapezoid. However, the section of the reflecting member 23 is not limited to the shape of the wide trapezoid in the present embodiment.

FIG. 2(E) is a sectional view schematically showing one lamp-fixing member 26. The lamp-fixing members 26 are used to fix the lamps 50. The design of the lamp-fixing members 26 is dependent on the number and positions of the lamps 50.

As shown in FIG. 2(A), according to the design of the backlight module, a plurality of holes 27 may be formed on the appropriate positions to fix the integrally formed reflector structure, the support frame (not shown in the drawing) and the optical films (not shown in the drawing).

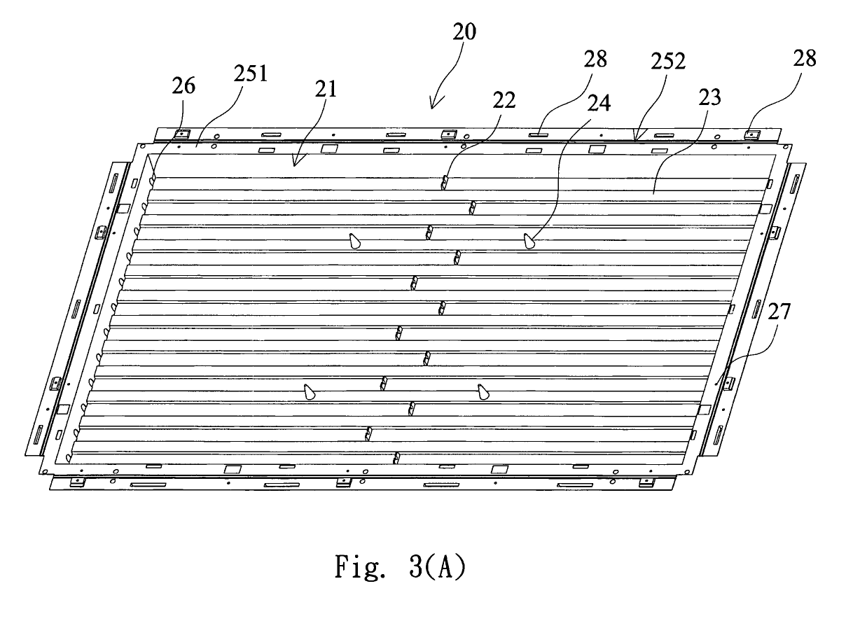

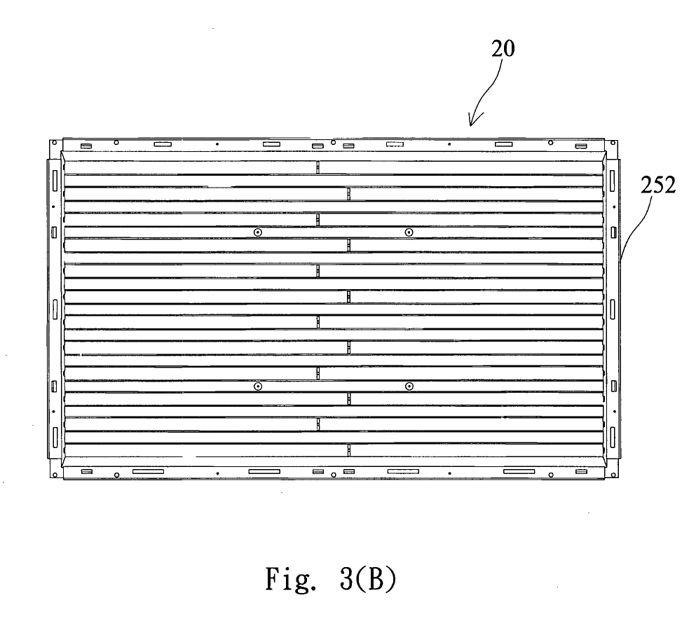

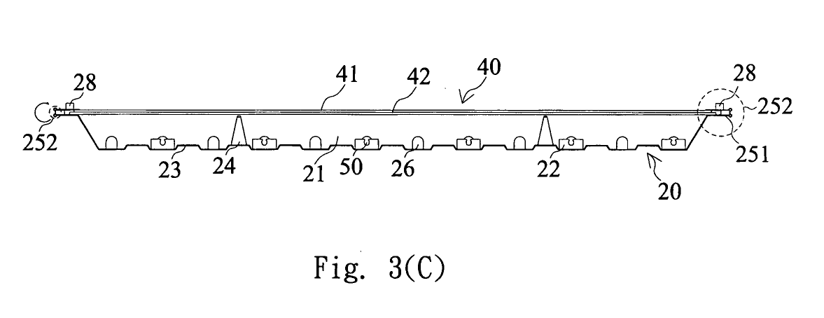

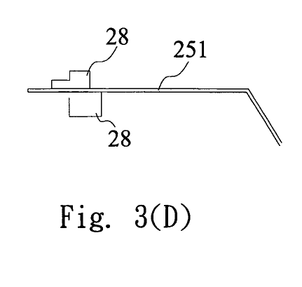

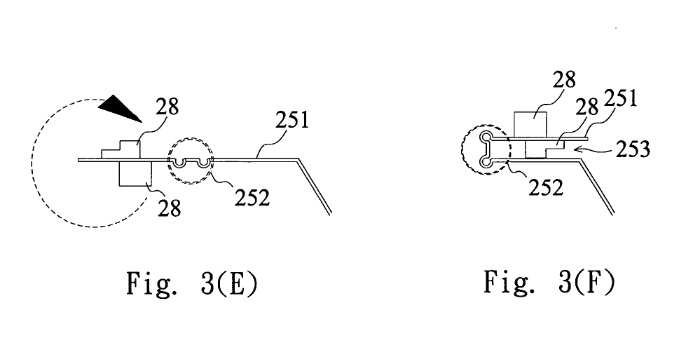

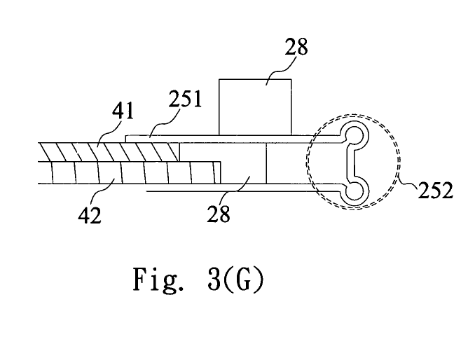

Refer to FIG. 3(A) to FIG. 3(C) for an integrally formed reflector structure according to another embodiment of the present invention. As shown in FIG. 3(A), the integrally formed reflector structure comprises a reflector baseplate 20 which is vacuum-formed to have an accommodation space 21, a plurality of lamp-support members 22, a plurality of support pins 24, a plurality of reflecting members 23, a plurality of lamp-fixing members 26, a plurality of extension portions 251, a plurality of bent portions 252, a plurality of holes 27, and a plurality of positioning members 28, and a plurality of lamps 50 are installed inside the accommodation space 21. The pluralities of bent portions 252 and positioning members 28 are formed in the extension portions 251 extending from the edges of the accommodation space 21.

As shown in FIG. 3(D), the positioning members 28 are formed in the extension portions 251 extending from the edges of the accommodation space 21 and used to position the optical films 40. The positioning members 28 may be a convex structure or a concave structure according to the design of the backlight module.

The bent portions 252 are formed in the extension portions 251 to absorb the stress generated in bending the extension portions 251. The extension portions 251 are bent from the bent portions 252 to form a plurality of grooves 253. Refer to FIG. 3(E) and FIG. 3(F) for the process of forming the grooves 253. Refer to FIG. 3(G), the groves 353 are used to accommodate a plurality of optical films 40, such as a polarizer film 41 and a diffuser plate 42. The concave or convex positioning members 28 are used to install the optical films 40 at appropriate positions.

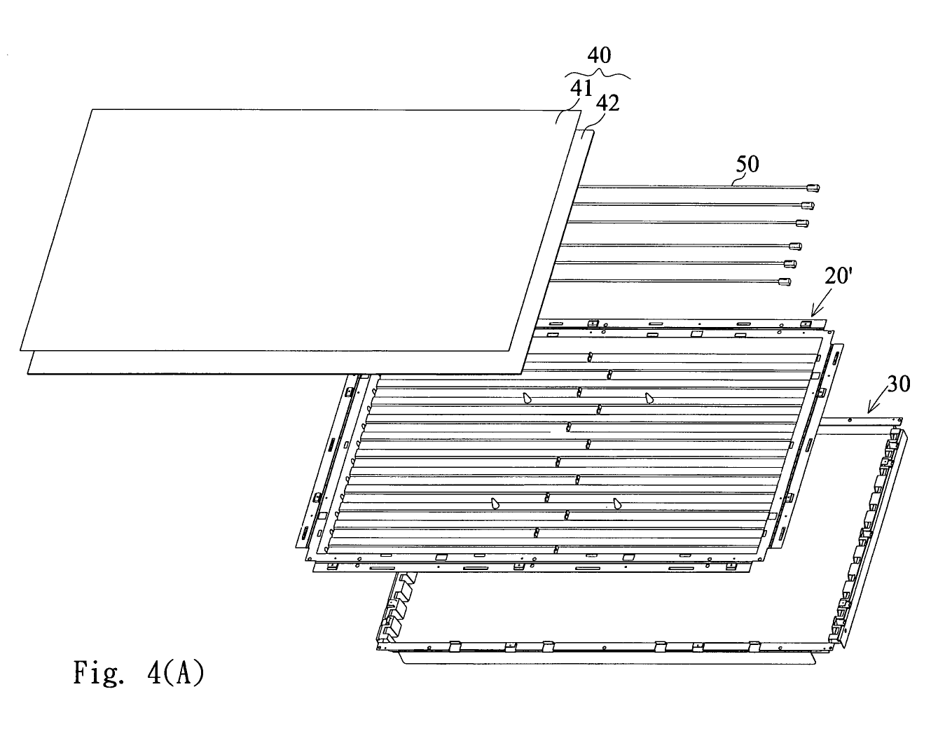

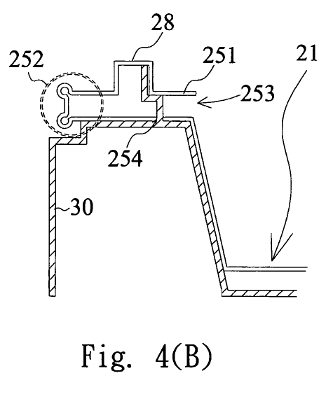

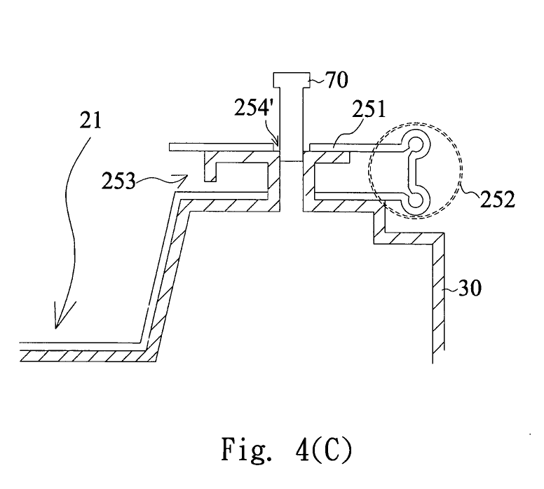

Refer to FIG. 4(A) which is an exploded view schematically showing a backlight module using the integrally formed reflector structure according to one embodiment of the present invention. The backlight module of the present embodiment comprises a support frame 30, a integrally formed reflector structure 20′ and a plurality of optical films 40. The optical films 40 are supported by the integrally formed reflector structure 20′, and the integrally formed reflector structure 20′ is assembled to the support frame 30. A screwing method, adhesion method or press-fit method is used to assemble the integrally formed reflector structure 20′, the optical films 40 and the support frame 30.

Refer to FIG. 4(B) which is a partially enlarged section view of the assembly of the integrally formed reflector and one support frame of the backlight module in FIG. 4(A). Extension portions 251 of an accommodation space 21 have bent portions 252, and the extension portions 251 are bent from the bent portions 252 to form grooves 253. Further, infix holes 254 are formed on the extension portions 251, and a support frame 30 is infixed into the infix holes 254 and secured thereto.

Refer to FIG. 4(C) which is a partially enlarged section view of the assembly of the integrally formed reflector and another support frame of the backlight module in FIG. 4(A). Extension portions 251 of an accommodation space 21 have bent portions 252, and the extension portions 251 are bent from the bent portions 252 to form grooves 253. Screw holes 254′ are respectively formed on the corresponding positions of the extension portions 251 and a support frame 30; then, screws 70 are used to fasten the reflector baseplate 20 and the support frame 30.

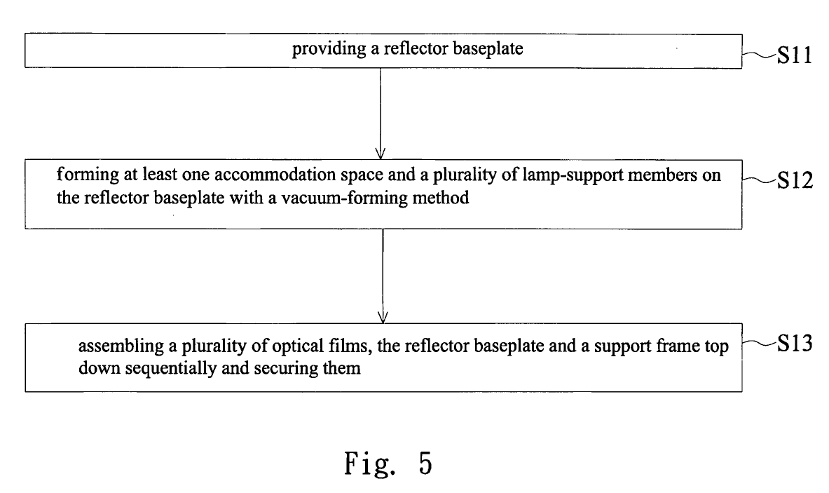

Refer to FIG. 5 which is a flowchart of a method for assembling a backlight module using a integrally formed reflector structure according to one embodiment of the present invention. In Step S11, a reflector baseplate 20 is provided first. In Step S12, the reflector baseplate 20 are vacuum-formed to have an accommodation space 21 and a plurality of lamp-support members 22. In Step S13, a plurality of optical films 40, the reflector baseplate 20 and a support frame 30 are sequentially with a top down manner assembled and secured, and the optical films 40, the reflector baseplate 20 and the support frame 30 are secured with a screwing method, adhesion method or press-fit method.

What is more, in Step S12, a plurality of support pins 24, a plurality of reflecting members 23 and a plurality of lamp-fixing members 26 are also vacuum-formed in the appropriate positions of the accommodation space 21. Further, in Step S12, a plurality of bent portions 252 and a plurality of positioning members 28 are also vacuum-formed on the extension portions 251 extending from the edges of the accommodation space 21.

Furthermore, before Step S13, the reflector baseplate 20 is perforated to form a plurality of holes 27. Before Step S13, the extension portions 251 extending from the edges of the accommodation space 21 are bent to accommodate optical films. Further, before Step S13, a plurality of lamps are secured to the lamp-support members 21 and the lamp-fixing members 26 inside the accommodation space 21.

In the embodiments of the present invention, the components required by a backlight module are all vacuum-formed in a reflector baseplate, such as the accommodation space, lamp-support members, support pins, reflecting members, lamp-fixing members, positioning members, bent portions, etc. In the embodiments of the present invention, the extension portions of the accommodation space are bent from the bent portions to form grooves for accommodating optical films. Thus, the present invention decreases the number of molds, reduces the cost of fabrication, simplifies the assembly process, and promotes the efficiency and yield of the assembly process.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An integrally formed reflector structure, used in a backlight module for supporting a plurality of optical films, comprising:
a reflector baseplate having an accommodation space, said accommodation space having a plurality of extension portions extending from edges thereof; and
a plurality of lamp-support members formed inside said accommodation space for supporting a plurality of lamps.

2. The integrally formed reflector structure according to claim 1 further comprising a plurality of support pins in said accommodation space for supporting said optical films.

3. The integrally formed reflector structure according to claim 1, wherein said reflector baseplate further comprising a plurality of reflecting members.

4. The integrally formed reflector structure according to claim 1 further comprising a plurality of lamp-fixing members arranged in said accommodation space for fixing said lamps.

5. The integrally formed reflector structure according to claim 4, wherein said accommodation space, said lamp-support members and said support pins are all vacuum-formed on said reflector baseplate.

6. The integrally formed reflector structure according to claim 1, wherein said optical films are secured to said extension portions with a screwing method, adhesion method or press-fit method.

7. The integrally formed reflector structure according to claim 1, wherein said extension portions have a plurality of bent portions, and said extension potions are bent from said bent portions to form a plurality of grooves for accommodating said optical films.

8. The integrally formed reflector structure according to claim 1, wherein said extension portions have a plurality of positioning members for securing said optical films.

9. The integrally formed reflector structure according to claim 8, wherein said positioning members are formed with a vacuum-forming method.

10. The integrally formed reflector structure according to claim 1, wherein said reflector baseplate is perforated to form a plurality of holes.

11. A method for assembling a backlight module using an integrally formed reflector structure, comprising steps:
(A) providing a reflector baseplate;
(B) forming at least one accommodation space and a plurality of lamp-support members on said reflector baseplate with a vacuum-forming method; and
(C) assembling a plurality of optical films, said reflector baseplate and a support frame sequentially with a top down manner, and securing them together.

12. The method for assembling a backlight module using an integrally formed reflector structure according to claim 11, wherein in said step (B), a plurality of support pins, a plurality of reflecting members and a plurality of lamp-fixing members are formed inside said accommodation space of said reflector baseplate with a vacuum-forming method.

13. The method for assembling a backlight module using an integrally formed reflector structure according to claim 11, wherein in said step (B), a plurality of bent portions and a plurality of positioning members are formed on extension portions extending from edges of said accommodation space with a vacuum-forming method.

14. The method for assembling a backlight module using an integrally formed reflector structure according to claim 13, wherein before said step (C), said extension portions are bent from said bent portions to accommodate said optical films.

15. The method for assembling a backlight module using an integrally formed reflector structure according to claim 11, wherein in said step (C), said reflector baseplate is perforated to form a plurality of holes.

16. The method for assembling a backlight module using an integrally formed reflector structure according to claim 11, wherein before said step (C), a plurality of lamps are secured inside said accommodation space.

17. The method for assembling a backlight module using an integrally formed reflector structure according to claim 11, wherein in said step (C), said optical films, said reflector baseplate and said support frame are secured with a screwing method, adhesion method or press-fit method.
